(19) United States
(12) Patent Application Publication
(10) Pub. No.: US 2024/0242862 A1
(43) Pub. Date: Jul. 18, 2024

(54) NEODYMIUM-IRON-BORON MAGNET PREPARED BY USING WASTE SINTERED MAGNET AND METHOD FOR PREPARING NEODYMIUM-IRON-BORON MAGNET BY USING WASTE MATERIALS

(71) Applicant: JL MAG RARE EARTH CO., LTD., Ganzhou, Jiangxi (CN)

(72) Inventors: Yunpeng CHEN, Ganzhou, Jiangxi (CN); Congyao MAO, Ganzhou, Jiangxi (CN); Huayun MAO, Ganzhou, Jiangxi (CN); Pengpeng YI, Ganzhou, Jiangxi (CN); Xin LAI, Ganzhou, Jiangxi (CN); Zhixin XU, Ganzhou, Jiangxi (CN)

(73) Assignee: JL MAG RARE EARTH CO., LTD., Ganzhou, Jiangxi (CN)

(21) Appl. No.: 18/561,752

(22) PCT Filed: Nov. 22, 2021
(86) PCT No.: PCT/CN2021/132075

§ 371 Date: Nov. 17, 2023

(30) Foreign Application Priority Data
Nov. 16, 2021 (CN) 202111354828.3

(51) Int. Cl. H01F 1/057; H01F 41/02

(52) U.S. Cl. CPC H01F 1/0577; H01F 41/0266

(57) ABSTRACT

A neodymium-iron-boron magnet prepared by using waste sintered magnet and method for preparing neodymium-iron-boron magnet by using waste materials are provided. A blended alloy having a specific composition is used in the process of preparing a neodymium-iron-boron magnet from a waste sintered magnet.

The present disclosure claims the priority to Chinese patent disclosure No. 202111354828.3 titled “NEODYMIUM-IRON-BORON MAGNET PREPARED BY USING WASTE SINTERED MAGNET METHOD AND FOR PREPARING NEODYMIUM-IRON-BORON MAGNET BY USING WASTE MATERIALS”, filed with the China National Intellectual Property Administration on Nov. 16, 2021, which is incorporated herein by reference in its entirety.

### FIELD

The present disclosure relates to the technical field of magnet preparation, and relates to a use of a formulated alloy in preparation of a neodymium iron boron magnet by using a waste sintered magnet, a neodymium iron boron magnet prepared by using a waste sintered magnet and a method thereof, in particular to a use of a formulated alloy in preparation of a neodymium iron boron magnet by using a waste sintered magnet, a neodymium iron boron magnet prepared by using a waste sintered magnet and a method of preparing a neodymium iron boron magnet by recycling a waste sintered magnet.

### BACKGROUND

It is known that a R—Fe—B rare earth sintered magnet with Nd₂Fe₁₄B compound as the main phase is a permanent magnet with the highest performance among all magnetic materials, which is widely used in a voice coil motor (VCM) of hard disk drive, a servo motor, a inverter air conditioner motor, an electric motor for hybrid vehicles, etc. The magnet production in the traditional method of the R—Fe—B rare earth sintered magnet is mainly through a process of smelting alloy, crashing, pressing, sintering and other processes. However, with the large-scale use of rare earth magnets, more and more waste magnets are produced during the production process as well as at the consumer end. The efficient recycling of the rare earth is very important, which not only protects the environment but also saves resources.

The conventional technology is mainly to add the waste magnet in the smelting process as a raw material after the surface thereof being cleaned, and smelt and make a new alloy by adding the waste magnet with the raw material. The smelting process will have some burning loss and lots of slag will be formed, which will affect the yield. In addition, the amount of waste magnets added is very limited, generally not more than 20%. Another method is to electrolytically extract the waste magnet. However, this method usually only extracts the rare earths while other elements will be wasted.

Therefore, how to find a more reasonable utilization method of the waste magnet, reduce the loss of the magnet, increase the processing capacity of the waste magnet, make more use of the components in the waste magnet, and achieve the purpose of multi-directional recycling, has become one of the urgent problems to be solved by many manufacturers and researchers in the industry.

### SUMMARY

In view of this, the technical problem to be solved by the present disclosure is to provide a method of preparing a new type of magnet by recycling magnet waste, especially a method of preparing a neodymium iron boron magnet by using waste materials. The waste magnetic steel of the present disclosure does not need to go through a smelting process, and instead the waste magnetic steel is directly crashed into powder and used. Since the directly reused waste magnetic steel has defects in the grain boundary phase and there are some impurities such as organic matter in the recycling process, a first alloy and a second alloy are introduced according to the present disclosure so as to mitigate the phase-rich defect of the waste magnetic steel and greatly improve the magnetic properties, realize 100% use of waste magnetic steel raw materials, and further improve the grain boundary structure by formulating the alloys to improve the efficiency of grain boundary penetration, reduce the waste of heavy rare earth resources, and at the same time, the process is simple and suitable for large-scale industrial production.

A use of a formulated alloy in preparation of a neodymium iron boron magnet by using a waste sintered magnet is provided according to the present disclosure.

The formulated alloy has a general formula as described in formula II:

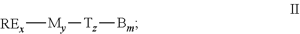

where 28 wt %≤x≤32 wt %, 0.35 wt %≤y≤1.6 wt %, 66 wt %≤z, 0.90 wt %≤m≤0.98 wt %, and x+y+z+m=100 wt %;
RE is selected from one or more of La, Ce, Ho, Gd, Pr, Nd, Dy and Tb;
M is selected from one or more of Al, Cu, Zn, Sn, Ga, Ge, Nb, V, W, Ti, Ni, Zr, Ta, Mn, Cd and Mo; and
T is selected from Fe and/or Co.

A neodymium iron boron magnet prepared by using a waste sintered magnet is provided according to the present disclosure, where the neodymium iron boron magnet is obtained by preparing a raw material including a waste neodymium iron boron magnet, a first alloy and a second alloy;
the second alloy has a general formula as described in formula II:

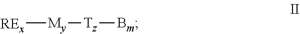

where 28 wt %≤x≤32 wt %, 0.35 wt %≤y≤1.6 wt %, 66 wt %≤z, 0.90 wt %≤m≤0.98 wt %, and x+y+z+m=100 wt %;
RE is selected from one or more of La, Ce, Ho, Gd, Pr, Nd, Dy and Tb;
M is selected from one or more of Al, Cu, Zn, Sn, Ga, Ge, Nb, V, W, Ti, Ni, Zr, Ta, Mn, Cd and Mo; and
T is selected from Fe and/or Co.

In an embodiment, the second alloy is a formulated alloy;
the formulation includes ingredient formulation and/or performance formulation;
an oxygen content of the second alloy is less than 1000 ppm; and
a grain size of the second alloy is 2 μm to 5 μm.

In an embodiment, the first alloy has a general formula as described in formula I:

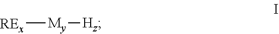

where 80 wt %≤x≤97 wt %, 2.5 wt %≤y≤20 wt %, 0.05 wt %≤z≤0.5 wt %, and x+y+z=100 wt %;
RE is selected from one or more of La, Ce, Ho, Gd, Pr, Nd, Dy and Tb;
M is selected from one or more of Al, Cu, Zn, Sn, Ga, Ge, Nb, V, W, Ti, Ni, Zr, Ta, Mn, Cd and Mo; and
H is hydrogen.

In an embodiment, the first alloy is a grain boundary addition phase alloy;
an oxygen content of the first alloy is less than 1000 ppm;
a particle size of the first alloy is less than or equal to 2 mm;
an oxygen content of the waste neodymium iron boron magnet is less than 2000 ppm; and
a particle size of the waste neodymium iron boron magnet is 0.2 mm to 2 mm.

In an embodiment, a mass ratio of the waste neodymium iron boron magnet to the first alloy is (90 to 99):(1 to 10);
a mass ratio of a total mass of the waste neodymium iron boron magnet and the first alloy to the second alloy is (10 to 95):(90 to 5);
the raw material further includes an antioxidant and/or a lubricant;
the raw material further includes a surface penetrated heavy rare earth element;
the heavy rare earth element includes Dy and/or Tb; and
a content of the surface penetrated heavy rare earth element in a total amount of the neodymium iron boron magnet is 0.2 wt % to 0.8 wt %.

A method of preparing a neodymium iron boron magnet by recycling a waste sintered magnet is provided according to the present disclosure, which includes the following steps:
1) crashing and hydrogen decrepitating the waste neodymium iron boron magnet to obtain a waste coarse powder; smelting and casting a first alloy raw material into a sheet or an ingot, and then hydrogen decrepitating the sheet or the ingot, to obtain a first alloy coarse powder;
2) mixing and grinding the waste coarse powder and the first alloy coarse powder obtained in the above step, to obtain a mixed fine powder;
3) remixing a second alloy powder and the mixed fine powder obtained in the above step to obtain a mixed powder; and
4) orientation forming and sintering the mixed powder obtained in the above step to obtain the neodymium iron boron magnet.

In an embodiment, a particle size after the hydrogen decrepitation is less than or equal to 2 mm; and
a thickness of the sheet after smelting and casting is 0.1 mm to 0.6 mm;
the waste neodymium iron boron magnet includes a magnet waste in a same magnet grade or a magnet waste in different magnet grades;
in the hydrogen decrepitation process, a hydrogen absorption time is 60 m to 180 m, and a hydrogen absorption temperature is 20° C. to 300° ° C.;
in the hydrogen decrepitation process, a dehydrogenation time is 3 h to 7 h, and a dehydrogenation temperature is 550° ° C. to 600° C.; and
after the hydrogen decrepitation, the method further includes a step of water cooling;
where a water cooling time is 0.5 h to 3 h.

In an embodiment, a particle size of the first alloy coarse powder is 0.2 mm to 2 mm;
an antioxidant is further added to be mixed in the mixing step;
a mass content of the antioxidant in the mixed fine powder is 0.02% to 0.1%;
the second alloy powder is obtained from a second alloy raw material after smelting, hydrogen decrepitation and jet milling;
in the remixing step, a lubricant is further added for remixing;
a mass content of the lubricant in the mixed powder is 0.02% to 0.1%; and
a particle size of the mixed powder is 2 μm to 5 μm.

In an embodiment, the orientation formation includes steps of orientation pressing and isostatic pressing;
the orientation formation and the isostatic pressing are in that: under a condition of oxygen-free or low oxygen, the orientation formation and the isostatic pressing are carried out;
a sintering temperature is 1030° ° C. to 1060° C.;
a sintering time is 6 h to 10 h;
after the sintering, the method further includes a step of an aging treatment;
where the aging treatment includes a first aging treatment and a second aging treatment;
a temperature of the first aging treatment is 700° C. to 950° C.;
a time of the first aging treatment is 2 h to 15 h;
a temperature of the second aging treatment is 350° C. to 550° ° C.;
a time of the second aging treatment is 1 h to 8 h;
after the sintering, the method further includes a step of penetration and diffusion;
the step of penetration and diffusion is in that: after the sintering and aging treatment, a surface of a magnet blank is coated with heavy rare earth, and then subjected to a heat treatment;
where the heat treatment includes a first heat treatment and a second heat treatment;
a temperature of the first heat treatment is 850° C. to 950° ° C.;
a time of the first heat treatment is 5 h to 15 h;
a temperature of the second heat treatment is 450° C. to 600° ° C.; and
a time of the second heat treatment is 3 h to 6 h.

A use of a formulated alloy in preparation of a neodymium iron boron magnet by using a waste sintered magnet is provided according to the present disclosure; the formulated alloy has a general formula as described in formula II; REₓ-M_{y}-T_{z}-Bₘ II. A method of preparing a neodymium iron boron magnet by using a waste sintered magnet is further provided according to the present disclosure. Compared with the prior art, the present disclosure aims at the problems that when the waste magnet is used as the raw material for smelting, there is partial burning loss and the formation of a lot of slag, which affects the yield, and the amount of waste magnetic steel added is very limited. According to the research of the present disclosure, in the process that the waste magnet is added to the smelting process as a raw material after the surface of the waste magnet is cleaned, the smelted alloy is subjected to a hydrogen decrepitation treatment and jet milling so as to obtain the fine waste powder. By adding heavy rare earth powder, the coercivity of the regenerated magnet is improved. In the method of mixing rich and high-abundance rare earth powder, increasing the rare earth content in the waste sintered neodymium iron boron powder to make it easy for sintering formation, and finally manufacturing the performance that meets the design requirements through pressing and sintering processes, mixing powder by adding heavy rare earth powder will cause waste of heavy rare earth resources, and it is not easy for subsequent grain boundary penetration and affects the diffusion efficiency due to the large amount of impurities in the waste and the small gap between the grain boundaries.

Based on this, the present disclosure creatively provides a formulated alloy with a specific composition, which is used in the process of the neodymium iron boron magnet prepared from the waste sintered magnet. The formulated alloy with a specific composition can not only flexibly formulate the composition and performance of the product to meet the design requirements to ensure the consistency of batch products, and improve the use rate of waste sintered magnets, but also facilitate of improving the diffusion performance, so that the present disclosure obtains a utilization method that can directly crash waste magnets into an alloy to be mixed with a rare-earth-rich alloy without smelting. It mitigates the phase-rich defect of waste magnetic steel and greatly improves the magnetic properties. In addition, it does not require smelting so as to reduce processing costs, while it can achieve 100% use of waste magnetic steel raw materials without being limited by the amount of smelting added.

In the method of preparing the neodymium iron boron magnet by recycling the waste sintered magnet according to the present disclosure, the waste magnet is made into an alloy powder, and then mixed with the corresponding rare earth-rich alloy powder according to the composition of the alloy. This process can improve the use rate of waste recycling, and solve the problems of limited addition of waste magnets in the smelting process, being partial burn-out and low yield, or the waste of other elements caused by the method of electrolytic refining of rare earths. Compared with adding waste in the smelting process, this process does not require smelting to reduce costs, and the process is simple with high flexibility, which can mass-produce magnets in different magnet grades. Further, a small amount of the first alloys with different compositions are added to optimize the grain boundary diffusion channels of the substrate and improve the efficiency of grain boundary penetration, which can effectively improve the impurity composition of the grain boundary phase, mitigate the defects in grain boundary of the wastes, significantly improve the coercivity performance, improve the grain boundary diffusion effect, and reduce the waste of heavy rare earth resources. Moreover, the fine powder of the formulated alloy (the second alloy) with different proportions are further added, which can not only flexibly formulate the composition and performance of the product to meet the design requirements, ensure the consistency of batch products, but also further improve the grain boundary diffusion performance and improve the grain boundary diffusion effect, improve the efficiency of grain boundary penetration, mitigate the defects in grain boundary of the wastes, and further improve the coercivity.

The utilization method according to the present disclosure aims to improve the recycling use of rare earths, save resources and reduce production costs. The present disclosure can efficiently recycle the waste material, the recycling use rate is high, and the use rate can be close to 100%, which can save resources and reduce costs. In the present disclosure, the processed waste magnets are directly made into the required alloy powder A through coarse crashing and hydrogen decrepitation. The addition of alloy B (the first alloy) can mitigate the defects in grain boundary of the wastes to improve the performance while improve the effect of grain boundary diffusion. By adding the fine powder of alloy C (second alloy) with different ratios to produce different grades of base material, the performance of the magnet can be further improved, and then the base material is manufactured into semi-finished products. Finally, after penetration, the required neodymium iron boron finished product is obtained, which has high production flexibility and high comprehensive use of resources.

The experimental results show that the utilization method according to the present disclosure can efficiently recycle the waste, the recycling use rate is high, close to 100% use, which can save resources and reduce costs.

### BRIEF DESCRIPTION OF THE DRAWINGS

FIG. 1 is a photograph of the metallographic structure of the neodymium iron boron magnet prepared in example 1 of the present disclosure; and

FIG. 2 is a photograph of the metallographic structure of the neodymium iron boron magnet prepared in comparative example 1 of the present disclosure.

### DETAILED DESCRIPTION

In order to further understand the present application, the preferred embodiments of the present application are described below in conjunction with the examples, but it should be understood that these descriptions are only for further illustrating the features and advantages of the present application, rather than limiting the claims of the present application.

All the raw materials of the present disclosure can be purchased in the market or prepared according to conventional methods well known to those skilled in the art, and the sources of which are not particularly limited.

All raw materials in the present disclosure are not particularly limited in their purity, and the present disclosure preferably adopts industrial purity or conventional purity used in the field of neodymium iron boron magnets.

A use of a formulated alloy in preparation of a neodymium iron boron magnet by using a waste sintered magnet is provided according to the present disclosure.

The formulated alloy has a general formula as described in formula II:

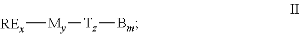

where, 28 wt %≤x≤32 wt %, 0.35 wt %≤y≤1.6 wt %, 66 wt %≤z, 0.90 wt %≤m≤0.98 wt %, and x+y+z+m=100 wt %;
RE is selected from one or more of La, Ce, Ho, Gd, Pr, Nd, Dy and Tb;
M is selected from one or more of Al, Cu, Zn, Sn, Ga, Ge, Nb, V, W, Ti, Ni, Zr, Ta, Mn, Cd and Mo; and
T is selected from Fe and/or Co.

In the present disclosure, RE is preferably selected from one or more of La, Ce, Ho, Gd, Pr, Nd, Dy and Tb, more preferably La, Ce, Ho, Gd, Pr, Nd, Dy or Tb.

In the present disclosure, M is preferably selected from one or more of Al, Cu, Zn, Sn, Ga, Ge, Nb, V, W, Ti, Ni, Zr, Ta, Mn, Cd and Mo, more preferably Al, Cu, Zn, Sn, Ga, Ge, Nb, V, W, Ti, Ni, Zr, Ta, Mn, Cd or Mo.

In the present disclosure, T is preferably selected from Fe and/or Co, more preferably Fe or Co.

In the present disclosure, x+y+z+m=100 wt %, the proportion of RE, that is, the x value is 28 wt % to 32 wt %, preferably 28.5 wt % to 31.5 wt %, more preferably 29 wt % to 31 wt %, more preferably 29.5 wt % to 30.5 wt %. The proportion of M, that is, the y value is 0.35 wt % to 1.6 wt %, preferably 0.65 wt % to 1.3 wt %, more preferably 0.95 wt % to 1.0 wt %. The proportion of T, that is, the z value is 66 wt %, preferably 63 wt %, more preferably 60 wt %. The proportion of B, that is, the m value is 0.90 wt % to 0.98 wt %, preferably 0.91 wt % to 0.97 wt %, more preferably 0.92 wt % to 0.96 wt %, more preferably 0.93 wt % to 0.95 wt %.

In the present disclosure, the formulated alloy is the second alloy or C alloy. The following further selections and parameters of the second alloy having the general formula as described in formula II can also be applied to the above applications.

The present disclosure has no particular limitation on the specific definition of the formula II or formula I, which can be expressed as such expressions well known to those skilled in the art. It can be understood as a mass ratio, a general formula, or a definition of other similar compositions.

A neodymium iron boron magnet prepared by using a waste sintered magnet is provided according to the present disclosure, where the neodymium iron boron magnet is obtained by preparing a raw material including a waste neodymium iron boron magnet, a first alloy and a second alloy;
the second alloy has a general formula as described in formula II:

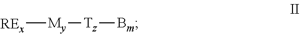

where, 28 wt %≤x≤32 wt %, 0.35 wt %≤y≤1.6 wt %, 66 wt %≤z, 0.90 wt %≤m≤0.98 wt %, and x+y+z+m=100 wt %;
RE is selected from one or more of La, Ce, Ho, Gd, Pr, Nd, Dy and Tb;
M is selected from one or more of Al, Cu, Zn, Sn, Ga, Ge, Nb, V, W, Ti, Ni, Zr, Ta, Mn, Cd and Mo; and
T is selected from Fe and/or Co.

In the present disclosure, RE is preferably selected from one or more of La, Ce, Ho, Gd, Pr, Nd, Dy and Tb, more preferably La, Ce, Ho, Gd, Pr, Nd, Dy or Tb.

In the present disclosure, M is preferably selected from one or more of Al, Cu, Zn, Sn, Ga, Ge, Nb, V, W, Ti, Ni, Zr, Ta, Mn, Cd and Mo, more preferably Al, Cu, Zn, Sn, Ga, Ge, Nb, V, W, Ti, Ni, Zr, Ta, Mn, Cd or Mo.

In the present disclosure, T is preferably selected from Fe and/or Co, more preferably Fe or Co.

In the present disclosure, x+y+z+m=100 wt %, the proportion of RE, that is, the x value is 28 wt % to 32 wt %, preferably 28.5 wt % to 31.5 wt %, more preferably 29 wt % to 31 wt %, more preferably 29.5 wt % to 30.5 wt %. The proportion of M, that is, the y value is 0.35 wt % to 1.6 wt %, preferably 0.65 wt % to 1.3 wt %, more preferably 0.95 wt % to 1.0 wt %. The proportion of T, that is, the z value is 66 wt %, preferably 63 wt %, more preferably 60 wt %. The proportion of B, that is, the m value is 0.90 wt % to 0.98 wt %, preferably 0.91 wt % to 0.97 wt %, more preferably 0.92 wt % to 0.96 wt %, more preferably 0.93 wt % to 0.95 wt %.

In the present disclosure, the second alloy is preferably a formulated alloy.

In the present disclosure, the oxygen content of the second alloy is preferably less than 1000 ppm, more preferably less than 900 ppm, more preferably less than 800 ppm.

In the present disclosure, the second alloy is preferably an alloy powder. The particle size of the second alloy is preferably 2 μm to 5 μm, more preferably 2.5 μm to 4.5 μm, and more preferably 3 μm to 4 μm.

In the present disclosure, the formulation preferably includes ingredient formulation and/or performance formulation, more preferably ingredient formulation and performance formulation. Further, the formulated alloy can also mitigate the defects in grain boundary and/or improve grain boundary diffusion effect and improve penetration effect, especially when used in combination with the first alloy.

In the present disclosure, the first alloy preferably has a general formula as described in formula I:

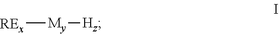

where, 80 wt %≤x≤97 wt %, 2.5 wt %≤y≤20 wt %, 0.05 wt %≤z≤0.5 wt %, and x+y+z=100 wt %;
RE is selected from one or more of La, Ce, Ho, Gd, Pr, Nd, Dy and Tb;
M is selected from one or more of Al, Cu, Zn, Sn, Ga, Ge, Nb, V, W, Ti, Ni, Zr, Ta, Mn, Cd and Mo; and
H is hydrogen element.

In the present disclosure, RE is preferably selected from one or more of La, Ce, Ho, Gd, Pr, Nd, Dy and Tb, more preferably La, Ce, Ho, Gd, Pr, Nd, Dy or Tb.

In the present disclosure, M is preferably selected from one or more of Al, Cu, Zn, Sn, Ga, Ge, Nb, V, W, Ti, Ni, Zr, Ta, Mn, Cd and Mo, more Preferably Al, Cu, Zn, Sn, Ga, Ge, Nb, V, W, Ti, Ni, Zr, Ta, Mn, Cd or Mo.

In the present disclosure, H is preferably hydrogen element.

In the present disclosure, x+y+z=100 wt %, the proportion of RE, that is, the x value is 80 wt % to 97 wt %, preferably 82 wt % to 95 wt %, more preferably 85 wt % to 92 wt %, more preferably 87 wt % to 9 wt %. The mass proportion of M, that is, the y value is 2.5 wt % to 20 wt %, preferably 4.5 wt % to 16 wt %, more preferably 8.5 wt % to 12 wt %. The mass ratio of the hydrogen element, that is, the z value is 0.05 wt % to 0.5 wt %, preferably 0.15 wt % to 0.4 wt %, more preferably 0.25 wt % to 0.3 wt %.

In the present disclosure, the first alloy is preferably a grain boundary addition phase alloy. Specifically, the grain boundary addition phase preferably includes mitigating the defects in grain boundary and/or improving grain boundary diffusion effects, more preferably mitigating the defects in grain boundary or improving grain boundary diffusion effects.

In the present disclosure, the melting point of the first alloy in the present disclosure is lower than the melting point of the grain boundary of the waste neodymium iron boron magnet alloy.

In the present disclosure, the oxygen content of the first alloy is preferably less than 1000 ppm, more preferably less than 900 ppm, more preferably less than 800 ppm.

In the present disclosure, the grain size of the first alloy is preferably less than or equal to 2 mm, more preferably less than or equal to 1.8 mm, preferably less than or equal to 1.6 mm.

In the present disclosure, the oxygen content of the waste neodymium iron boron magnet is preferably less than 2000 ppm, more preferably less than 1900 ppm, more preferably less than 1800 ppm.

In the present disclosure, the particle size of the waste neodymium iron boron magnet is preferably 0.2 mm to 2 mm, more preferably 0.6 mm to 1.6 mm, and more preferably 1.0 mm to 1.2 mm.

In the present disclosure, the mass ratio of the waste neodymium iron boron magnet to the first alloy is preferably (90 to 99):(1 to 10), more preferably (92 to 97):(1 to 10), more preferably (94 to 95):(1 to 10), more preferably (90 to 99):(3 to 8), more preferably (90 to 99):(5 to 6).

In the present disclosure, the mass ratio of the total mass of the waste neodymium iron boron magnet and the first alloy to the second alloy is preferably (10 to 95):(90 to 5), more preferably (30 to 75):(90 to 5), more preferably (50 to 55):(90 to 5), more preferably (10 to 95):(70 to 25), more preferably (10 to 95):(50 to 45).

In the present disclosure, the raw materials preferably include an antioxidant and/or a lubricant, more preferably an antioxidant or a lubricant.

In the present disclosure, the raw material preferably further includes a surface penetrated heavy rare earth element.

In the present disclosure, the heavy rare earth element preferably includes Dy and/or Tb, more preferably Dy or Tb.

In the present disclosure, the content of the surface penetrated heavy rare earth element in the total amount of the neodymium iron boron magnet is preferably 0.2 wt % to 0.8 wt %, more preferably 0.3 wt % to 0.7 wt %, more preferably 0.4 wt % to 0.6 wt %.

In the present disclosure, the rare earth mainly refers to La, Ce, Ho, Gd, Pr, Nd, Dy and Tb.

In the present disclosure, the waste magnets refer to wastes or wasted materials in the magnet manufacturing process, as well as sintered neodymium iron boron magnets removed from motors and components after being wasted at the consumer end.

A method of preparing a neodymium iron boron magnet by recycling a waste sintered magnet is provided according to the present disclosure, which includes the following steps:
1) the waste neodymium iron boron magnet is crashed and hydrogen decrepitated to obtain a waste coarse powder;
a first alloy raw material is smelted and casted into a sheet or an ingot, and crashed by the hydrogen to obtain a first alloy coarse powder;
2) the waste coarse powder and the first alloy coarse powder obtained in the above step are mixed and ground to obtain a mixed fine powder;
3) a second alloy powder and the mixed fine powder obtained in the above step are remixed to obtain a mixed powder; and
4) the mixed powder obtained in the above step is orientation formed and sintered to obtain the neodymium iron boron magnet.

In the present disclosure, the waste neodymium iron boron magnets are firstly crashed and hydrogen decrepitated to obtain the waste coarse powder.

After the first alloy raw material is smelted and cast into a sheet or an ingot, and then is subjected to a hydrogen decrepitation, the first alloy coarse powder is obtained.

In the present disclosure, the particle size after crashing is preferably less than or equal to 30 mm, more preferably less than or equal to 20 mm, and more preferably less than or equal to 10 mm.

In the present disclosure, the particle size after the hydrogen decrepitation is preferably equal to or less than 2 mm, more preferably equal to or less than 1.9 mm, and more preferably equal to or less than 1.8 mm.

In the present disclosure, the thickness of the sheet after melting and casting is preferably 0.1 mm to 0.6 mm, more preferably 0.2 mm to 0.5 mm, and more preferably 0.3 mm to 0.4 mm.

In the present disclosure, the waste neodymium iron boron magnet preferably includes a magnet waste in a same magnet grade or a magnet waste in different magnet grades.

In the present disclosure, in the hydrogen decrepitation process, the hydrogen absorption time is preferably 60 m to 180 m, more preferably 80 m to 160 m, and more preferably 100 m to 140 m. The hydrogen absorption temperature is preferably 20° C. to 300° C., more preferably 60° C. to 260° C., more preferably 100° C. to 220° ° C., and more preferably 140° C. to 180° C.

In the present disclosure, in the hydrogen decrepitation process, the dehydrogenation time is preferably 3 h to 7 h, more preferably 3.5 h to 6.5 h, more preferably 4 h to 6 h, more preferably 4.5 h to 5.5 h, and the dehydrogenation temperature is preferably 550° C. to 600° ° C., more preferably 560° C. to 590° C., more preferably 570° C. to 580° ° C.

In the present disclosure, after the hydrogen decrepitation, the method preferably includes a step of water cooling.

In the present disclosure, the water cooling time is preferably 0.5 h to 3 h, more preferably 1 h to 2.5 h, and more preferably 1.5 h to 2 h.

In the present disclosure, the waste coarse powder obtained in the above steps is mixed with the first alloy coarse powder, and the mixed fine powder is obtained after grinding.

In the present disclosure, the particle size of the first alloy coarse powder is preferably 0.2 mm to 2 mm, more preferably 0.6 mm to 1.6 mm, and more preferably 1.0 mm to 1.2 mm.

In the present disclosure, the antioxidant is preferably added and mixed in the mixing step.

In the present disclosure, the mass content of the antioxidant in the mixed fine powder is preferably 0.02% to 0.1%, more preferably 0.06% to 0.16%, and more preferably 0.1% to 0.12%.

In the present disclosure, the second alloy powder and the mixed fine powder obtained in the above steps are remixed to obtain the mixed powder.

In the present disclosure, the second alloy powder is preferably obtained from the second alloy raw material after smelting, hydrogen decrepitation and jet milling.

In the present disclosure, in the remixing step, a lubricant is preferably added for remixing.

In the present disclosure, the mass content of the lubricant in the mixed powder is preferably 0.02% to 0.1%, more preferably 0.06% to 0.16%, and more preferably 0.1% to 0.12%.

In the present disclosure, the particle size of the mixed powder is preferably 2 μm to 5 μm, more preferably 2.5 μm to 4.5 μm, and more preferably 3 μm to 4 μm.

In the present disclosure, the mixed powder obtained in the above steps is subjected to orientation formation and sintering to obtain a neodymium iron boron magnet.

In the present disclosure, the sintering preferably includes a step of penetration and diffusion. Specifically, the step of penetration and diffusion is preferably in that: after being coated with heavy rare earth (being penetrated with heavy rare earth elements), the surface of the sintered and aged magnet blank is then subjected to a heat treatment.

In the present disclosure, the heat treatment preferably includes a first heat treatment and a second heat treatment.

In the present disclosure, the temperature of the first heat treatment is preferably 850° ° C. to 950° C., more preferably 870° C. to 930° ° C., and more preferably 890° C. to 910° C.

In the present disclosure, the time of the first heat treatment is preferably 5 h to 15 h. more preferably 7 h to 13 h, and more preferably 9 h to 11 h.

In the present disclosure, the temperature of the second heat treatment is preferably 450° ° C. to 600° C., more preferably 480° ° C. to 570° C., and more preferably 510° C. to 540° C.

In the present disclosure, the time of the second heat treatment is preferably 3 h to 6 h, more preferably 3.5 h to 5.5 h, and more preferably 4 h to 5 h.

According to the method of preparing a neodymium iron boron magnet by using waste sintered magnets provided in the present disclosure, the surface coating is removed from the waste magnet, and then the so-called raw material is subjected to primary crashing, and then the primary crashed material is subjected to hydrogen decrepitation to produce alloy powder A. The first alloy mainly composed of rare earth is smelted, and the first alloy powder B is produced by hydrogen decrepitation. The alloy powder and the first alloy powder are mixed into the alloy AB, and the alloy AB is subjected to jet milling to obtain the fine powder AB. According to the composition of the AB formula and the target composition, an alloy C (second alloy) for the formulating the composition properties is designed, and the alloy C is obtained from the new raw material through smelting, hydrogen decrepitation, and jet milling, which is in alloy fine powder C. The fine powder AB and the fine powder C are stirred, formed, sintered and other processes to produce a blank that conforms to the design.

The overall recycling process is completed and refined in the present disclosure, which better improves the efficiency of grain boundary penetration, further reduces the phase-rich defects of the waste magnetic steel, improves the magnetic properties, better realizes 100% use of the waste magnetic steel raw materials, and better guarantees the performance of the finished magnet. The above method for recycling waste sintered magnets can specifically include the following steps.

1. In the present disclosure, pretreatments such as coating-removal, degreasing, cleaning, etc. are conducted for the waste neodymium iron boron magnet, which is a block magnet, and the oxygen content of which is below 5000 ppm, so that the oxygen content is below 2000 ppm after the surface being cleaned, and then initial crashing is carried out, the particle size after crashing is less than 30 mm, and then hydrogen decrepitation treatment is carried out, and the particle size after crashing is 200 μm to 2 mm. This alloy is called alloy A.

2. REₓ-M_{y}-H_{z} powder is prepared as the grain boundary additive phase, and the size of the powder is less than 2 mm. This alloy is called alloy B (the first alloy).

The REₓ-M_{y}-H_{z} alloy powder is added to the alloy A as a phase-rich alloy, where RE is selected from at least one element of La, Ce, Ho, Gd, Pr, Nd, Dy and Tb, and M is selected from at least one element of Al, Cu, Zn, Sn, Ga, Ge, Nb, V, W, Ti, Ni, Zr, Ta, Mn, Cd and Mo, H is hydrogen, where 80 wt %≤x≤97 wt %, 2.5 wt %≤y≤20 wt %, 0.05 wt %≤z≤0.5 wt %, and x+y+z=100 wt %.

The oxygen content of the REₓ-M_{y}-H_{z} alloy powder is below 1000 ppm. In the present disclosure, the melting point of the alloy B is lower than the melting point of the alloy A grain boundary. The main function of the alloy B is to mitigate the defects in grain boundary of the wastes, improve the performance and improve the effect of grain boundary diffusion. The present disclosure has no particular limitation on the production process of the alloy B, and the production process is well known to those skilled in the art.

3. REₓ-M_{y}-T_{z}-Bₘ surplus powder is prepared as a formulated alloy for formulating the performance. The size of the powder is 2 μm to 5 μm. This alloy is called alloy C (the second alloy).

The REₓ-M_{y}-T_{z}-Bₘ alloy powder as the formulated alloy is mixed with AB powder, where RE is selected from at least one element of La, Ce, Ho, Gd, Pr. Nd, Dy and Tb, M is selected from at least one element of Al, Cu, Zn, Sn, Ga, Ge, Nb, V, W, Ti, Ni, Zr, Ta, Mn, Cd and Mo, R is at least one element of Fe and Co, where 28 wt %≤x≤32 wt %, 0.35 wt %≤y≤1.6 wt %, 66 wt %≤z. 0.90 wt %≤m≤0.98 wt %, and x+y+z+m=100 wt %.

The oxygen content of the REₓ-M_{y}-T_{z}-Bₘ alloy powder is below 1000 ppm, and the alloy C is used to flexibly formulate the composition and performance of the product to meet design requirements. The present disclosure has no particular limitation on the manufacturing process of the alloy C, and the production process is well known to those skilled in the art.

4. The alloy A and the alloy B in an appropriate ratio (Aₓ-B₁₋ₓ, where 90 wt %≤x≤99 wt %) are mixed to obtain alloy AB. The antioxidant is added to the alloy AB to stir and mix, and then jet milling is carried out so as to obtain fine powder AB with an average particle size of 2 μm to 5 μm.

5. According to the composition and target composition of the AB formula, an alloy C is designed for formulating the properties of the composition. The alloy C is obtained from new raw materials through smelting, hydrogen decrepitation and jet milling, which is in a fine powder C with an average particle size of 2 μm to 5 μm.

6. The fine powder AB and the fine powder C are mixed in an appropriate ratio ((AB)_{y}C_{1-y}, where 10 wt %≤y≤95 wt %), and then the lubricant is added to stir and mix evenly. Then, orientation formation, sintering and other processes are carried out to manufacture sintered neodymium iron boron magnets. The diffusion performance will be better by adding C.

7. The sintered neodymium iron boron magnet is manufactured into a sample in 2 mm sheet, and the sheet sample is penetrated with 0.6 wt % Tb to obtain a penetrated product.

The above steps of the present disclosure relate to the use of a formulated alloy in preparation of a neodymium iron boron magnet by using a waste sintered magnet, a neodymium iron boron magnet prepared by using a waste sintered magnet and a method of preparing a neodymium iron boron magnet by recycling the waste sintered magnet. The present disclosure provides a formulated alloy with a specific composition, which is used in the process of the neodymium iron boron magnet prepared from the waste sintered magnet. The formulated alloy with a specific composition can not only flexibly formulate the composition and performance of the product to meet the design requirements, ensure the consistency of batch products, and improve the use rate of the waste sintered magnets, but also facilitate of improving the diffusion performance. Therefore, the present disclosure can obtain a utilization method that can directly crash waste magnets into an alloy and a rare-earth-rich alloy without smelting, and mitigates the phase-rich defect of waste magnetic steel and greatly improves the magnetic properties. In addition, it does not require smelting so as to reduce processing costs, while it can achieve 100% use of waste magnetic steel raw materials without being limited by the amount of smelting added.

In the method of preparing the neodymium iron boron magnet by recycling the waste sintered magnet according to the present disclosure, the waste magnet is made into an alloy powder, and then mixed with the corresponding rare earth-rich alloy powder according to the composition of the alloy. This process can improve the use rate of waste recycling, and solve the problems of limited addition of waste magnets in the smelting process, being partial burn-out and low yield, or the waste of other elements caused by the method of electrolytic refining of rare earths. Compared with adding waste in the smelting process, this process does not require smelting to reduce costs, the process is simple with high flexibility, which can mass-produce magnets in different magnet grades. Further, a small amount of the first alloys with different compositions are added to optimize the grain boundary diffusion channels of the substrate and improve the efficiency of grain boundary penetration, which can effectively improve the impurity composition of the grain boundary phase, mitigate the defects in grain boundary of the wastes, significantly improve the coercivity performance, improve the grain boundary diffusion effect, and reduce the waste of heavy rare earth resources. Moreover, the fine powder of the formulated alloy (the second alloy) with different proportions are further added, which can not only flexibly formulate the composition and performance of the product to meet the design requirements, ensure the consistency of batch products, but also further improve the grain boundary diffusion performance and improve the grain boundary diffusion effect, improve the efficiency of grain boundary penetration, mitigate the defects in grain boundary of the wastes, and further improve the coercivity.

The utilization method according to the present disclosure aims to improve the recycling use of the rare earths, save resources and reduce production costs. In the present disclosure, the processed waste magnets are directly made into the required alloy powder A through coarse crashing and hydrogen decrepitation. The addition of alloy B (the first alloy) can mitigate the defects in grain boundary of the wastes so as to improve the performance while improve the effect of grain boundary diffusion. By further adding the fine powder of alloy C (the second alloy) with different ratios to produce different grades of base material, the performance of the magnet can be further improved, and then the base material is manufactured into semi-finished products, finally, after penetration, the required neodymium iron boron finished product is obtained, which has high production flexibility and high comprehensive use of resources.

The experimental results show that the utilization method according to the present disclosure can efficiently recycle the waste, the recycling use rate is high, close to 100% use, which can save resources and reduce costs.

In order to further illustrate the present disclosure, the use of the formulated alloy provided by the present disclosure in the preparation of neodymium iron boron magnets by using waste sintered magnets, a neodymium iron boron magnet prepared by using a waste sintered magnet and the method thereof will be described in detail below with reference to the examples. However, it should be understood that these examples are implemented on the premise of the technical solution of the present application, and the detailed implementation manner and specific operation process are given, only to further illustrate the features and advantages of the present application, rather than to claim the present application. The protection scope of the present application is not limited to the following examples.

### Example 1

### 1. Preparation of Alloy A

1.1 The neodymium iron boron waste is subjected to pretreatment such as coating removal, degreasing and cleaning.

1.2 The bulk raw materials are initially crashed, and the particle size after crashing is less than 30 mm. The present disclosure does not have special restrictions on the crashing equipment and conditions, and those skilled in the art can choose different equipment according to actual production conditions.

1.3 Carry out a production process of the alloy sheets by hydrogen decrepitation (HD), the process of the hydrogen absorption time is 75 min, then dehydrogenation at 580° ° C. for 5 h, and finally water-cooled for 2 h to obtain coarse powder alloy A. The composition of coarse powder A is measured, see Table 1. Table 1 shows the component content of the alloy A in example 1.

TABLE 1

| Element | Pr | Nd | Dy | Ho | B | Al | Cu | Co | Zr | Ti | Ga | Fe |
|---|---|---|---|---|---|---|---|---|---|---|---|---|
| Content wt % | 5.7 | 22.8 | 0.85 | 0.53 | 0.95 | 0.16 | 0.1 | 0.54 | 0.08 | 0.05 | 0.13 | Surplus |

### 2. Preparation of Alloy B

2.1. Design the composition of phase-rich alloy B \textcircled{1}Pr21 Nd70 Cu2 Al4 Ga3 according to the composition of the alloy.

2.2. Smelt, the known method of making alloy sheets with a vacuum induction melting furnace can be appropriate; the thickness of the produced sheets is 0.10 mm to 0.60 mm.

2.3. Carry out a production process of the alloy sheets by hydrogen decrepitation (HD), the process of hydrogen absorption time is 75 min, then dehydrogenation at 580° C. for 5 h, and finally water-cooled for 2 h to obtain coarse powder (alloy B).

3. Mix the alloy A and alloy B according to A:B=98%:2% to obtain alloy AB; and an antioxidant is added in alloy AB for stirring and mixing.

4. The above AB coarse powder is manufactured with jet mill to obtain fine powder AB with an average particle size of 3.0 μm.

5. Design a composition of alloy C \textcircled{1}Pr_{6.3}Nd_{23.5}B_{0.94}Cu_{0.1}Al_{0.15}Ga_{0.1}Ti_{0.1}Feₛᵤᵣₚₗᵤₛ according to the composition of the alloy, and alloy C is obtained from new raw materials through smelting, hydrogen decrepitation and jet milling, which is in fine powder C with an average particle size of 2 μm to 5 μm.

6. The ratio of fine powder AB:fine powder C is made to be equal to 70%:30%, then a lubricant is added to stir and mix evenly.

7. The proportioned fine powder ABC is subjected to magnetic field orientation formation and isostatic pressing; the magnetic field orientation formation is carried out in a sealed oxygen-free or hypoxic glove box to ensure that the product is oxygen-free or hypoxic throughout the whole operation and isostatic pressing.

8. The neodymium iron boron magnet is obtained by vacuum sintering and aging heat treatment. Vacuum sintering is carried out in a vacuum sintering furnace, the sintering temperature is 1050° C., and the sintering time is 6 h; the aging is carried out in two times, the temperature of the first aging heat treatment is 920° C., and the time is 2 h; the aging temperature of the second aging heat treatment is 550° C., and the time is 5 h.

9. The sintered magnet is manufactured into a 2 mm sheet, and the two sides of the sheet are respectively coated with heavy rare earth, and then heat treatment is carried out to obtain the penetrated product. The coating amount of heavy rare earth is 0.5 wt %, and the heat treatment process is 900° C.*8 h+490° C.*5 h.

The neodymium iron boron magnet prepared in example 1 of the present disclosure is characterized.

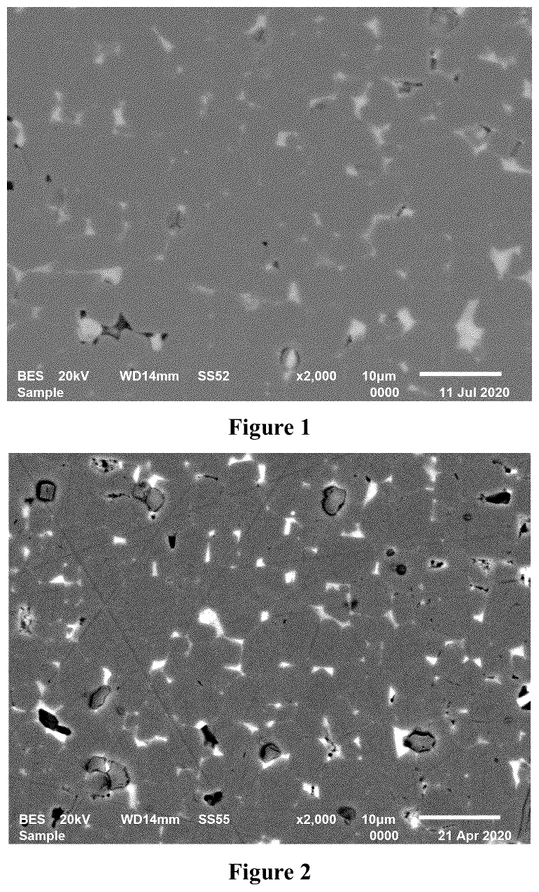

Referring to FIG. 1, FIG. 1 is a photograph of the metallographic structure of the neodymium iron boron magnet prepared in example 1 of the present disclosure.

The neodymium iron boron magnets prepared in example 1 and comparative example 1 of the present disclosure are tested, respectively.

Referring to Table 3, Table 3 shows the magnet performance data of example 1 and comparative example 1 before and after implementation.

### Comparative Example 1

### 1. Preparation of Alloy A

1.1 The neodymium iron boron waste is subjected to pretreatment such as coating removal, degreasing and cleaning.

1.2 The bulk raw materials are initially crashed, and the particle size after crashing is less than 30 mm. The present disclosure does not have special restrictions on the crashing equipment and conditions, and those skilled in the art can choose different equipment according to actual production conditions.

1.3 Carry out a production process of the alloy sheets treated by hydrogen decrepitation (HD), the process of the hydrogen absorption time is 75 min, then dehydrogenation at 580° ° C. for 5 h, and finally water-cooled for 2 h to obtain coarse powder alloy A. The composition of coarse powder A is measured, see Table 2. Table 2 shows the composition content of the alloy A in comparative example 1.

TABLE 2

| Element | Pr | Nd | Dy | Ho | B | Al | Cu | Co | Zr | Ti | Ga | Fe |
|---|---|---|---|---|---|---|---|---|---|---|---|---|
| Content wt % | 5.7 | 22.8 | 0.85 | 0.53 | 0.95 | 0.16 | 0.1 | 0.54 | 0.08 | 0.05 | 0.13 | Surplus |

2. An antioxidant is added to the alloy A for stirring and mixing.

3. The above coarse powder A is manufactured with jet mill to obtain fine powder A with an average particle size of 3.0 μm.

### 4. Preparation of Alloy B

4.1. Design a composition of phase-rich alloy B \textcircled{1}Pr21 Nd70 Cu2 Al4 Ga3 according to the composition of the alloy.

4.2. Smelt, the known method of making alloy sheets with a vacuum induction melting furnace can be appropriate; the thickness of the produced sheets is 0.10 mm to 0.60 mm.

4.3. Carry out a production process of the alloy sheets by hydrogen decrepitation (HD), the process of the hydrogen absorption time is 75 min, then dehydrogenation at 580° C. for 5 h, and finally water-cooled for 2 h to obtain coarse powder (alloy B).

5. Mix the alloy A and the alloy B according to A:B=98%:2% to obtain the alloy AB; the antioxidant is added to the alloy AB for stirring and mixing.

6. The above AB coarse powder is manufactured with jet mill to obtain fine powder AB with an average particle size of 3.0 μm; and the powder AB is subjected to magnetic field orientation formation and isostatic pressing; the magnetic field orientation formation is carried out in a sealed oxygen-free or hypoxic glove box to ensure that the product is oxygen-free or hypoxic throughout the whole operation and isostatic pressing.

7. The neodymium iron boron magnet is obtained by vacuum sintering and aging heat treatment. Vacuum sintering is carried out in a vacuum sintering furnace, the sintering temperature is 1050° C., and the sintering time is 6 h; the aging is carried out in two times, the temperature of the first aging heat treatment is 920° C., and the time is 2 h; the aging temperature of the second aging heat treatment is 550° ° C., and the time is 5 h.

8. The sintered magnet is manufactured into a 2 mm sheet, and the two sides of the sheet are respectively coated with heavy rare earth, and then heat treatment is carried out to obtain the penetrated product. The coating amount of heavy rare earth is 0.5 wt %, and the heat treatment process is 900° C.*8 h+490° C.*5 h.

The neodymium iron boron magnet prepared in comparative example 1 of the present disclosure is characterized.

Referring to FIG. 2, FIG. 2 is a photograph of the metallographic structure of the neodymium iron boron magnet prepared in comparative example 1 of the present disclosure.

The neodymium iron boron magnets prepared in example 1 and comparative example 1 of the present disclosure are tested, respectively.

Referring to Table 3, Table 3 shows the magnet performance data of example 1 and comparative example 1 before and after implementation.

TABLE 3

| | | | | Pene- |
|---|---|---|---|---|
| | | | | trat- |
| | | | | ing |
| | | | | Hcj |
| | | Br | Hcj | Incre- |
| Sample Lable | | (kGs) | (kOe) | ment |
| Exam- | Magnetic properties before penetration | 14.15 | 16.7 | 10.6 |
| ple 1 | Magnetic properties after penetration | 13.97 | 27.3 | |
| Compara- | Magnetic properties before penetration | 14.24 | 15.4 | 9.1 |
| tive Ex- | Magnetic properties after penetration | 14.01 | 24.5 | |
| ample 1 | | | | |

### Example 2

### 1. Preparation of Alloy A

1.1 The neodymium iron boron waste is subjected to pretreatment such as coating removal, degreasing and cleaning.

1.2 The bulk raw materials are initially crashed, and the particle size after crashing is less than 30 mm. The present disclosure does not have special restrictions on the crashing equipment and conditions, and those skilled in the art can choose different equipment according to actual production conditions.

1.3 Carry out a production process of the alloy sheets by hydrogen decrepitation (HD), the process of the hydrogen absorption time is 75 min, then dehydrogenation at 580° C. for 5 h, and finally water-cooled for 2 h to obtain coarse powder alloy A. The composition of coarse powder A is measured, see Table 4. Table 4 shows the component content of the alloy A in example 2.

TABLE 4

| Element | Pr | Nd | Dy | Ho | B | Al | Cu | Co | Zr | Ti | Ga | Fe |
|---|---|---|---|---|---|---|---|---|---|---|---|---|
| Content wt % | 5.8 | 22.7 | 0.5 | 0.42 | 0.94 | 0.18 | 0.11 | 0.5 | 0.07 | 0.05 | 0.11 | Surplus |

### 2. Preparation of Alloy B

2.1. Design the composition of phase-rich alloy B is designed \textcircled{1}Pr20 Nd61Dy10 Cu2 Al4 Ga3 according to the composition of the alloy.

2.2. Smelt, the known method of making alloy sheets with a vacuum induction melting furnace can be appropriate; the thickness of the produced sheets is 0.10 mm to 0.60 mm.

2.3. Carry out a production process of the alloy sheets by hydrogen decrepitation (HD), the process of the hydrogen absorption time is 75 min, then dehydrogenation at 580° ° C. for 5 h, and finally water-cooled for 2 h to obtain coarse powder (alloy B).

3. Mix the alloy A and the alloy B according to A:B=97%:3% to obtain alloy AB; and an antioxidant is added in the alloy AB for stirring and mixing.

4. The above AB coarse powder is manufactured with jet mill to obtain fine powder AB with an average particle size of 3.0 μm.

5. Design a composition of alloy C \textcircled{1}Pr_{6.1}Nd_{22.7} Dy_{0.5}B_{0.94}Cu_{0.1}Al_{0.15}Ga_{0.1}Ti_{0.1}Fe_{Surplus} according to the composition of the alloy, and the alloy C is obtained from new raw materials through smelting, hydrogen decrepitation and jet milling, which is in fine powder C with an average particle size of 2 μm to 5 μm.

6. The ratio of fine powder AB:fine powder C is made to be equal to 60%:40%, then a lubricant is added to stir and mix evenly.

7. The proportioned fine powder ABC is subjected to magnetic field orientation formation and isostatic pressing; the magnetic field orientation formation is carried out in a sealed oxygen-free or hypoxic glove box to ensure that the product is oxygen-free or hypoxic throughout the whole operation and isostatic pressing.

8. The neodymium iron boron magnet is obtained by vacuum sintering and aging heat treatment. Vacuum sintering is carried out in a vacuum sintering furnace, the sintering temperature is 1050° C., and the sintering time is 6 h; the aging is carried out in two times, the temperature of the first aging heat treatment is 920° C., and the time is 2 h; the aging temperature of the second aging heat treatment is 550° ° C., and the time is 5 h.

9. The sintered magnet is manufactured into a 2 mm sheet, and the two sides of the sheet are respectively coated with heavy rare earth, and then heat treatment is carried out to obtain the penetrated product. The coating amount of heavy rare earth is 0.5 wt %, and the heat treatment process is 900° C.*8 h+490° C.*5 h.

The neodymium iron boron magnets prepared in example 2 and comparative example 2 of the present disclosure are tested.

Referring to Table 6, Table 6 shows the magnet performance data of example 2 and comparative example 2 before and after implementation.

### Comparative Example 2

### 1. Preparation of Alloy A

1.1 The neodymium iron boron waste is subjected to pretreatment such as coating removal, degreasing and cleaning.

1.2 The bulk raw materials are initially crashed, and the particle size after crashing is less than 30 mm. The present disclosure does not have special restrictions on the crashing equipment and conditions, and those skilled in the art can choose different equipment according to actual production conditions.

1.3 Carry out a production process of the alloy sheets treated by hydrogen decrepitation (HD), the process of the hydrogen absorption time is 75 min, then dehydrogenation at 580° ° C. for 5 h, and finally water-cooled for 2 h to obtain coarse powder alloy A. The composition of coarse powder A is measured, see Table 5. Table 5 shows the composition content of the alloy A in comparative example 2.

TABLE 5

| Element | Pr | Nd | Dy | Ho | B | Al | Cu | Co | Zr | Ti | Ga | Fe |
|---|---|---|---|---|---|---|---|---|---|---|---|---|
| Content wt % | 5.8 | 22.7 | 0.5 | 0.42 | 0.94 | 0.18 | 0.11 | 0.5 | 0.07 | 0.05 | 0.11 | Surplus |

2. An antioxidant is added to the alloy A for stirring and mixing.

3. The above coarse powder A is manufactured with jet mill to obtain fine powder A with an average particle size of 3.0 μm.

### 4. Preparation of Alloy B

4.1. Design a composition of phase-rich alloy B \textcircled{1}Pr20 Nd61Dy10 Cu2 Al4 Ga3 according to the composition of the alloy.

4.2. Smelt, the known method of making alloy sheets with a vacuum induction melting furnace can be appropriate; the thickness of the produced sheets is 0.10 mm to 0.60 mm.

4.3. Carry out a production process of the alloy sheets by hydrogen decrepitation (HD), the process of the hydrogen absorption time is 75 min, then dehydrogenation at 580° C. for 5 h, and finally water-cooled for 2 h to obtain coarse powder (alloy B).

5. Mix the alloy A and the alloy B according to A:B=97%:3% to obtain the alloy AB; the antioxidant is added to the alloy AB for stirring and mixing.

6. The above AB coarse powder is manufactured with jet mill to obtain fine powder AB with an average particle size of 3.0 μm; and the powder AB is subjected to magnetic field orientation formation and isostatic pressing; the magnetic field orientation formation is carried out in a sealed oxygen-free or hypoxic glove box to ensure that the product is oxygen-free or hypoxic throughout the whole operation and isostatic pressing.

7. The neodymium iron boron magnet is obtained by vacuum sintering and aging heat treatment. Vacuum sintering is carried out in a vacuum sintering furnace, the sintering temperature is 1050° C., and the sintering time is 6 h; the aging is carried out in two times, the temperature of the first aging heat treatment is 920° ° C., and the time is 2 h; the aging temperature of the second aging heat treatment is 550° ° C., and the time is 5 h.

8. The sintered magnet is manufactured into a 2 mm sheet, and the two sides of the sheet are respectively coated with heavy rare earth, and then heat treatment is carried out to obtain the penetrated product. The coating amount of heavy rare earth is 0.5 wt %, and the heat treatment process is 900° C.*8 h+490° C.*5 h.

The neodymium iron boron magnets prepared in example 2 and comparative example 2 of the present disclosure are tested.

Referring to Table 6, Table 6 shows the magnet performance data of example 2 and comparative example 2 before and after implementation.

TABLE 6

| | | | | Pene- |
|---|---|---|---|---|
| | | | | trat- |
| | | | | ing |
| | | | | Hcj |
| | | Br | Hcj | Incre- |
| Sample Lable | | (kGs) | (kOe) | ment |
| Exam- | Magnetic properties before penetration | 14.07 | 17.6 | 10.8 |
| ple 2 | Magnetic properties after penetration | 13.88 | 28.4 | |
| Compara- | Magnetic properties before penetration | 14.06 | 16.3 | 9.4 |
| tive Ex- | Magnetic properties after penetration | 13.83 | 25.7 | |
| ample 2 | | | | |

A use of the formulated alloy in the preparation of a neodymium iron boron magnet by using a waste sintered magnet, a neodymium iron boron magnet prepared by using a waste sintered magnet, and a method of preparing a neodymium iron boron magnet by recycling a waste sintered magnet according to the present disclosure are described in detail above. The principles and implementations of the present application are described herein by using specific examples. The descriptions of the above examples are only used to help understand the method and the core idea of the present application, including the best mode, and also enable any technology in the field. Any person is capable of practicing the present application, including making and using any devices or systems, and performing any incorporated methods. It should be pointed out that for those skilled in the art, without departing from the principle of the present application, several improvements and modifications can also be made to the present application, and these improvements and modifications also fall within the protection scope of the claims of the present application. The scope of patent protection of the present application is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A use of a formulated alloy in preparation of a neodymium iron boron magnet by using a waste sintered magnet; wherein
the formulated alloy has a general formula as described in formula II: 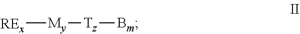
wherein 28 wt %≤x≤32 wt %, 0.35 wt %≤y≤1.6 wt %, 66 wt %≤z, 0.90 wt %≤m≤0.98 wt %, and x+y+z+m=100 wt %;
RE is selected from one or more of La, Ce, Ho, Gd, Pr, Nd, Dy and Tb;
M is selected from one or more of Al, Cu, Zn, Sn, Ga, Ge, Nb, V, W, Ti, Ni, Zr, Ta, Mn, Cd and Mo; and
T is selected from Fe and/or Co.

2. A neodymium iron boron magnet prepared by using a waste sintered magnet, wherein the neodymium iron boron magnet is obtained by preparing a raw material comprising a waste neodymium iron boron magnet, a first alloy and a second alloy;
the second alloy has a general formula as described in Formula II: 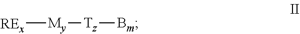
wherein 28 wt %≤x≤32 wt %, 0.35 wt %≤y≤1.6 wt %, 66 wt %≤z, 0.90 wt %≤m≤0.98 wt %, and x+y+z+m=100 wt %;
RE is selected from one or more of La, Ce, Ho, Gd, Pr, Nd, Dy and Tb;
M is selected from one or more of Al, Cu, Zn, Sn, Ga, Ge, Nb, V, W, Ti, Ni, Zr, Ta, Mn, Cd and Mo; and
T is selected from Fe and/or Co.

3. The neodymium iron boron magnet according to claim 2, wherein the second alloy is a formulated alloy;
the formulation comprises ingredient formulation and/or performance formulation;
an oxygen content of the second alloy is less than 1000 ppm; and
a grain size of the second alloy is 2 μm to 5 μm.

4. The neodymium iron boron magnet according to claim 2, wherein the first alloy has a general formula as described in formula I: 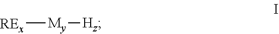
wherein 80 wt %≤x≤97 wt %, 2.5 wt %≤y≤20 wt %, 0.05 wt %≤z≤0.5 wt %, and x+y+z=100 wt %;
RE is selected from one or more of La, Ce, Ho, Gd, Pr, Nd, Dy and Tb;
M is selected from one or more of Al, Cu, Zn, Sn, Ga, Ge, Nb, V, W, Ti, Ni, Zr, Ta, Mn, Cd and Mo; and
H is hydrogen.

5. The neodymium iron boron magnet according to claim 4, wherein the first alloy is a grain boundary addition phase alloy;
an oxygen content of the first alloy is less than 1000 ppm;
a particle size of the first alloy is less than or equal to 2 mm;
an oxygen content of the waste neodymium iron boron magnet is less than 2000 ppm; and
a particle size of the waste neodymium iron boron magnet is 0.2 mm to 2 mm.

6. The neodymium iron boron magnet according to claim 2, wherein a mass ratio of the waste neodymium iron boron magnet to the first alloy is (90 to 99):(1 to 10);
a mass ratio of a total mass of the waste neodymium iron boron magnet and the first alloy to the second alloy is (10 to 95):(90 to 5);
the raw material further comprises an antioxidant and/or a lubricant;
the raw material further comprises a surface penetrated heavy rare earth element;
the heavy rare earth element comprises Dy and/or Tb; and
a content of the surface penetrated heavy rare earth element in a total amount of the neodymium iron boron magnet is 0.2 wt % to 0.8 wt %.

7. A method of preparing a neodymium iron boron magnet by recycling a waste sintered magnet, comprises the following steps:
1) crashing and hydrogen decrepitating the waste neodymium iron boron magnet to obtain a waste coarse powder;
smelting and casting a first alloy raw material into a sheet or an ingot, and then hydrogen decrepitating the sheet or the ingot to obtain a first alloy coarse powder;
2) mixing and then grinding the waste coarse powder and the first alloy coarse powder obtained in the above step, to obtain a mixed fine powder;
3) remixing a second alloy powder and the mixed fine powder obtained in the above step to obtain a mixed powder; and
4) orientation-forming and sintering the mixed powder obtained in the above step to obtain the neodymium iron boron magnet.

8. The method according to claim 7, wherein a particle size after the hydrogen decrepitation is less than or equal to 2 mm; and
a thickness of the sheet after smelting and casting is 0.1 mm to 0.6 mm;
the waste neodymium iron boron magnet comprises a magnet waste in a same magnet grade or a magnet waste in different magnet grades;
in the hydrogen decrepitation process, a hydrogen absorption time is 60 m to 180 m, and a hydrogen absorption temperature is 20° ° C. to 300° ° C.;
in the hydrogen decrepitation process, a dehydrogenation time is 3 h to 7 h, and a dehydrogenation temperature is 550° ° C. to 600° C.; and
after the hydrogen decrepitation, further comprising a step of water cooling,
wherein a water cooling time is 0.5 h to 3 h.

9. The method according to claim 7, wherein a particle size of the first alloy coarse powder is 0.2 mm to 2 mm;
an antioxidant is further added to be mixed in the mixing step;
a mass content of the antioxidant in the mixed fine powder is 0.02% to 0.1%;
the second alloy powder is obtained from a second alloy raw material after smelting, hydrogen decrepitation and jet milling;
in the remixing step, a lubricant is further added for remixing;
a mass content of the lubricant in the mixed powder is 0.02% to 0.1%; and
a particle size of the mixed powder is 2 μm to 5 μm.

10. The method according to claim 7, wherein the orientation formation comprises steps of orientation pressing and isostatic pressing;
the orientation formation and the isostatic pressing are in that: under a condition of oxygen-free or low oxygen, the orientation formation and the isostatic pressing are carried out;
a sintering temperature is 1030° ° C. to 1060° C.;
a sintering time is 6 h to 10 h;
after the sintering, further comprising a step of an aging treatment;
wherein the aging treatment comprises a first aging treatment and a second aging treatment;
a temperature of the first aging treatment is 700° C. to 950° C.;
a time of the first aging treatment is 2 h to 15 h;
a temperature of the second aging treatment is 350° C. to 550° ° C.;
a time of the second aging treatment is 1 h to 8 h;
after the sintering, further comprising a step of penetration and diffusion;
the step of penetration and diffusion is in that: after the sintering and aging treatment, a surface of a magnet blank is coated with heavy rare earth, and then subjected to a heat treatment;
wherein the heat treatment comprises a first heat treatment and a second heat treatment;
a temperature of the first heat treatment is 850° C. to 950° C.;
a time of the first heat treatment is 5 h to 15 h;
a temperature of the second heat treatment is 450° C. to 600° C.; and
a time of the second heat treatment is 3 h to 6 h.
